(19) United States
(12) Patent Application Publication
(10) Pub. No.: US 2007/0290992 A1
(43) Pub. Date: Dec. 20, 2007

(54) Control interface for media player

(75) Inventors: Boon Keat Eddy Toh, Singapore (SG); Kin Fui Chong, Singapore (SG); Ka Wei Adrian Wong, Singapore (SG); Jeng Khim Tan, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd

(21) Appl. No.: 11/454,264

(22) Filed: Jun. 16, 2006

(51) Int. Cl. G09G 5/08

(52) U.S. Cl. 345/157

(57) ABSTRACT

There is provided a media player including a casing with a front panel mounted thereon; the front panel including at least one touch sensor; and at least one mechanical switch incorporated within the casing. It is preferable that a combination of activating at least one touch sensor, and activating the at least one mechanical switch at least once is required for the activation of at least one function from a first set of functions of the media player. The media player may be an audio media player, a video media player, a digital photo viewer or a combination of the aforementioned. Associated methods to provide instructions to the media player are also disclosed.

### FIELD OF INVENTION

This invention relates to a control interface for a media player and refers particularly, though not exclusively, to such an interface that is enabled by the use of at least one touch sensor and a single tactile switch.

### BACKGROUND

Consumers nowadays face a myriad of choices when selecting a personal digital entertainment device. Given that personal tastes largely dictate the selection of the device, it can be said that both the appearance and usability of the device are equally important when it comes to selecting the device. In some instances, the usability of the device is the sole distinguishing feature for the device, further highlighting its importance.

There are many ways of implementing a control interface on a personal digital entertainment device. The controls may be purely mechanical as in the case of the Zen Neeon from Creative Technology Ltd, the controls may be purely electronic like a touch sensitive surface as in the case of the Zen Micro from Creative Technology Ltd, or it may be a combination of both as in the case of the Zen Vision M from Creative Technology Ltd. Some users may prefer both the physical feedback attainable from mechanical controls with the convenience and simplicity of electronic controls.

One of the ways of providing physical feedback is by using tactile (mechanical) switches in the personal digital entertainment device. Generally, the greater the number of switches being used, the higher the chance of at least one of the switches being defective.

### SUMMARY

There is provided a media player including a casing with a front panel mounted thereon; the front panel including at least one touch sensor; and at least one mechanical switch incorporated within the casing. It is preferable that a combination of activating at least one touch sensor, and activating the at least one mechanical switch at least once is required for the activation of at least one function from a first set of functions of the media player. The media player may be an audio media player, a video media player, a digital photo viewer or a combination of the aforementioned.

It is preferable that the media player includes a first opening for a display in the front panel. A scrolling activator may also be located in the front panel for tasks such as, for example, controlling longitudinal movement of a cursor/selector on the display or selecting items shown on the display. The scrolling activator may be located in a second opening in the front panel, the second opening is of a width that is greater than the scrolling activator.

It is preferable that the at least one touch sensor is coupled to the mechanical switch to provide an indication of an input when the at least one touch sensor on the front panel is activated. The indication of an input may be, for example, a physical force, an audible sound emanating from the tactile switch or an audible sound generated from the media player. Preferably, the front panel is marked with indicia corresponding to positions of touch sensors. Advantageously, the at least one mechanical switch may be activated beyond a pre-determined duration to invoke a second set of functions of the media player, where the pre-determined duration is between two to three seconds.

There is also provided a method to provide instructions to a media player, including: determining whether a touch sensor is activated; determining whether at least one mechanical switch is activated; and determining the incidence of activation of the at least one mechanical switch.

It is preferable that feedback is provided to a user when a combination of the touch sensor and the at least one mechanical switch is activated, and instructions are provided to the media player. The feedback may be a physical force, an audible sound emanating from the tactile switch or an audible sound generated from the media player.

An alternative method to provide instructions to a media player is also provided. The alternative method includes determining whether a touch sensor is activated; determining whether at least one mechanical switch is activated; and determining whether the at least one mechanical switch is activated beyond a pre-determined duration. It is preferable that feedback is provided to a user when a combination of the touch sensor and the at least one mechanical switch is activated, and instructions are provided to the media player. It is advantageous that instructions are invoked from a second level of functions of the media player when the mechanical switch is activated beyond a pre-determined duration of between two to three seconds. Preferably, the feedback may be a physical force, an audible sound emanating from the tactile switch and an audible sound generated from the media player.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 is an exploded view of a first embodiment of the present invention.

FIG. 2 is an underside of the front panel of the first embodiment of the present invention.

FIG. 3 is an exploded view of an alternative first embodiment of the present invention.

FIG. 4 is a base view of the first embodiment of the present invention.

FIG. 5 is a front view of a second embodiment of the present invention.

FIG. 6 is a front view of an alternative second embodiment of the present invention.

FIG. 7 shows the locations of the sensors in the alternative second embodiment of the present invention.

FIG. 8 shows a front view of the scrolling activator of the second embodiment of the present invention.

FIG. 9 is a base view of the second embodiment of the present invention.

FIG. 10 is a flow chart of a method utilised in the present invention.

FIG. 11 is a flow chart of an alternative method utilised in the present invention.

### DESCRIPTION OF PREFERRED EMBODIMENTS

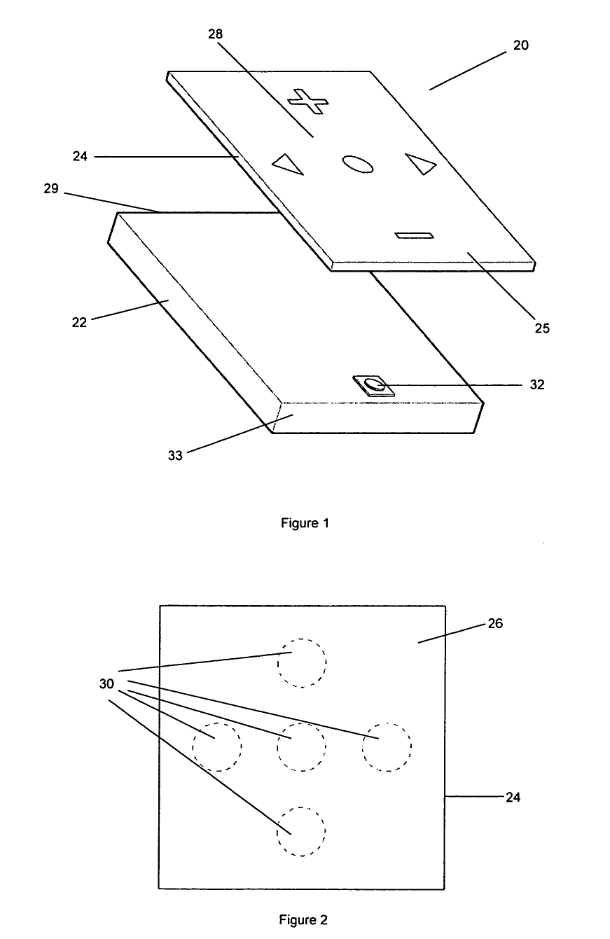

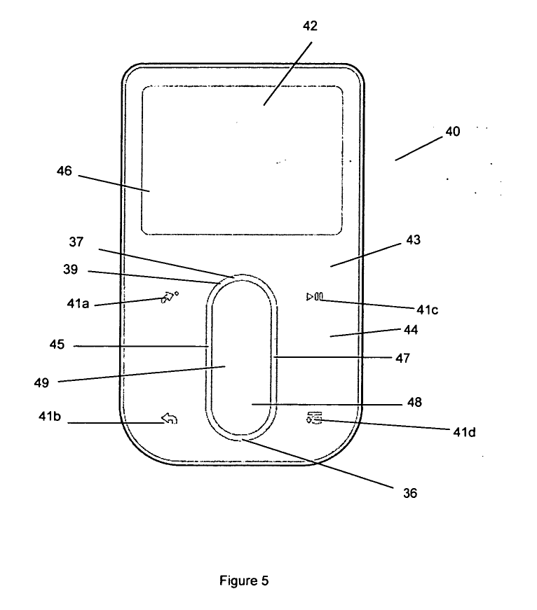

Referring to FIGS. 1 and 4, there is provided an exploded view and a base view of a first embodiment of the present invention respectively. There is shown a media player 20. The media player 20 may be an audio media player, a video media player, a digital photo viewer or a combination of the aforementioned. The media player 20 shown in FIG. 1 is an audio media player. The media player 20 has a casing 22 and a front panel 24. An underside 26 of the front panel 24 is shown in FIG. 2. The front panel 24 shows control indicia 28 on top surface 25. Pressing a “+” sign or “−” sign on the front panel 24 would increase and decrease a volume of audio playback respectively. Similarly, pressing a “□” or a “□” sign on the front panel 24 would enable skipping/selection of audio files stored in or accessible by the media player 20. In addition, pressing a “□” sign on the front panel 24 would enable audio files to be played back or paused.

Referring to FIG. 2, the underside 26 of the front panel 24 shows touch sensors 30 located at positions corresponding to where control indicia 28 are positioned on the top surface 25 of the front panel 24. The touch sensors 30 may detect contact with the top surface 25 of the front panel 24 either by heat detection or by force detection. However, contact may only be detected if the location of contact corresponds to a location of the touch sensor 30. The greater the number of touch sensors 30, the greater the number of positions that may detect contact on the top surface 25 of the front panel 24.

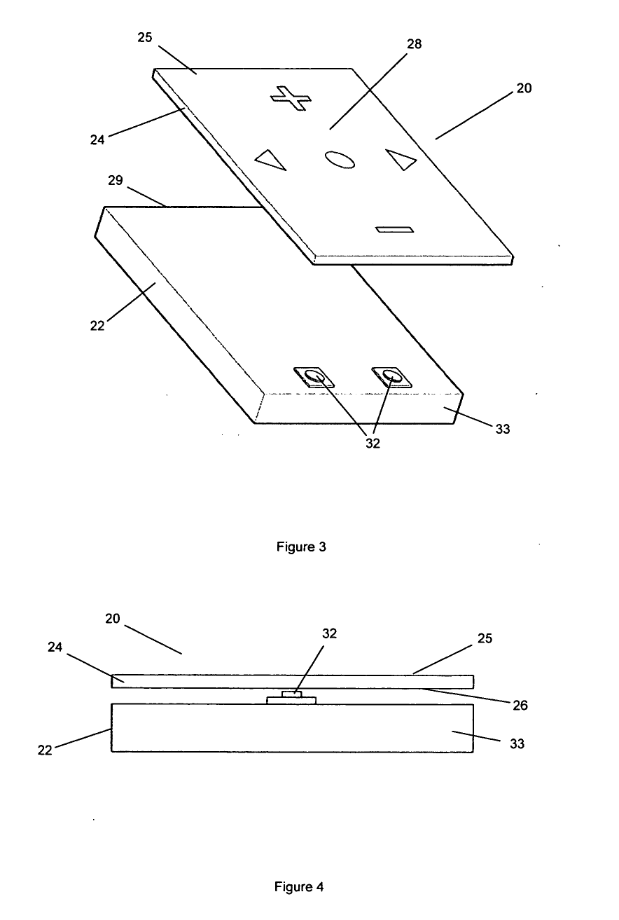

The casing 22 of the media player 20 includes a tactile (mechanical) switch 32 incorporated at or in close proximity to a base 33 of the casing 22. FIG. 3 shows an alternative first embodiment of the present invention where there may be more than one switch 32, in this instance, two. However, it is preferable that the number of switches 32 is not overly excessive and is less than the number of sensors 30 on the front panel 24. When the media player 20 is assembled for use, the front panel 24 is mounted onto the casing 22. The front panel 24 may be mounted onto the casing 22 in a manner where contact with the top surface 25 of the front panel 24 results in the tactile switch 32 being compressed. One way that the front panel 24 may be mounted onto the casing 22 may be by hinging the front panel 24 at a top edge 29 of the casing 22. Such a method of mounting may then allow for the compression of the tactile switch 32 wherever contact with the top surface 25 of the front panel 24 is made by a user. Alternatively, the front panel 24 may be mounted using other methods and the tactile switch 32 need not be located at or in close proximity to a base 33 of the casing 22. This is possible if a tactile switch 32 that is activate-able when in either a compressed or de-compressed state is employed in the media player 20.

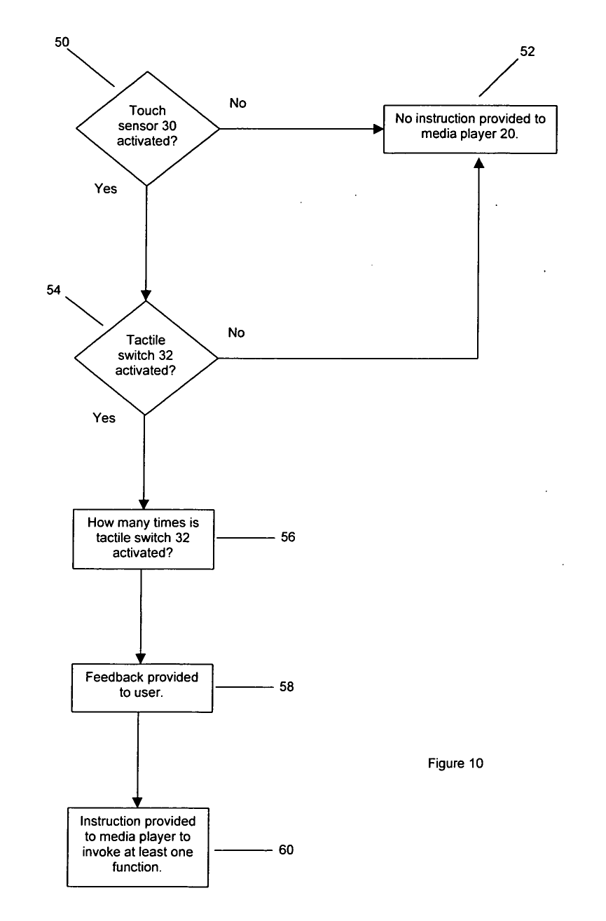

Referring to FIG. 10, there is shown a method employed in the media player 20 to enable instructions to be provided to the media player 20 by the user. Firstly, a processor in the media player 20 may determine whether at least one touch sensor 30 is activated (50). If activation of at least one touch sensor 30 is not detected, then no instructions are sent to the media player 20 (52). If activation of at least one touch sensor 30 is detected, the processor in the media player 20 then determines whether the tactile switch 32 is activated (54). If activation of the tactile switch 32 is not detected, then no instructions are sent to the media player 20 (52). Subsequently, if activation of the tactile switch 32 is detected, the processor then determines how many times the tactile switch 32 is activated (56). After determining the number of times the tactile switch 32 is activated, feedback corresponding to the number of times that the tactile switch 32 is activated is provided to a user (58). The feedback may be an audible sound emanating from the tactile switch (like a mechanical “click”) or an audible sound generated from the media player 20 (like a digital “beep”). The feedback may also be in a form of a physical force like from a rebound of a pushbutton switch. Subsequently, instructions are then provided to the media player 20 to invoke at least one function of the media player 20 (60).

It may be possible to invoke a function of the media player 20 by contacting one or a combination of touch sensors 30 and activating the tactile switch 32 at least once. Activating the tactile switch 32 more than once may invoke a different function. Thus the feedback aids the user in controlling the media player 20 by providing an indication with regard to the number of times the tactile switch 32 is activated, and correspondingly, the number of times one or a combination of touch sensors are being contacted. In addition, the two-step check for touch sensor 30 plus tactile switch 32 activations also aid in minimising the incidence of unintentional/accidental activation of media player 20 functions. Having one switch 32 per touch sensor 30 may be excessive as the greater the number of components, the greater the probability of component failure.

Referring to FIGS. 5 and 9, there is shown a front and a base view of a second embodiment of the present invention respectively. A media player 40 that includes a display 42 and is able to function as a video/audio media player, and a digital photo viewer is shown. A front panel 44 is shown which includes a first opening 46 for the display 42 and a second opening 48 for a scrolling activator 49 for controlling longitudinal movement of a cursor/selector for content shown on the display 42. The second opening 48 may be of a width that is greater than the scrolling activator 49. When the media player 40 is assembled for use, the front panel 44 may be mounted onto a casing 35.

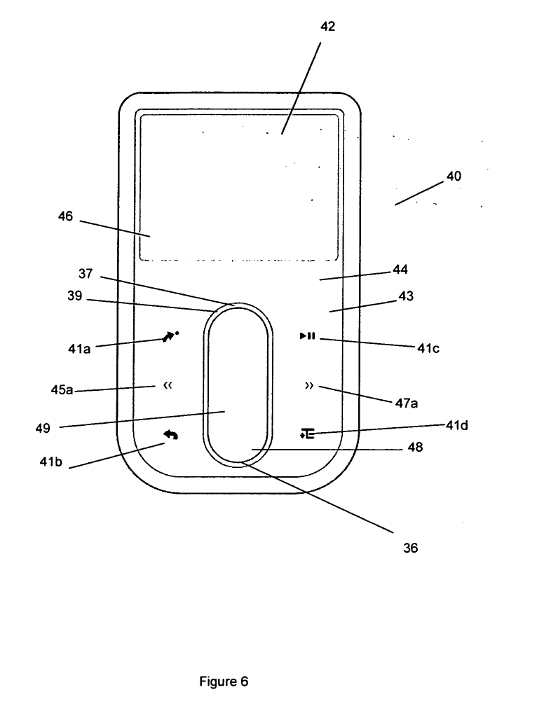

There are four indicia 41a, 41b, 41c and 41d on a top surface 43 of the front panel 44. In addition, there are four touch sensors 102 located at corresponding positions with the four indicia 41a, 41b, 41c and 41d on an underside surface 100 of the front panel 44 (FIG. 7). A tactile switch (not shown) is also incorporated in the media player 40 as per the first embodiment of the present invention. Thus, the manner of invoking instructions for the media player 40 is identical to that described for the first embodiment of the present invention, where the touch sensors work in combination with the tactile switch(es) to invoke instructions for the media player 40. Latitudinal movement of the cursor/selector for content shown on the display 42 may be controlled by contact with a first straight side 45 (for latitudinal movement of the cursor/selector on the display 42 in a first direction) and a second straight side 47 (for latitudinal movement of the cursor/selector on the display 42 in a second direction) of a rim 39 on the front panel 44 surrounding the scrolling activator 49. The first straight side 45 and the second straight side 47 of the rim 39 may also have touch sensors 104 located on the corresponding underside surface of the front panel 44 (FIG. 7) and the touch sensors 104 work in combination with the tactile switch(es) to invoke instructions (latitudinal movement of the cursor/selector on the display 42) for the media player 40. Alternatively, latitudinal movement in the first direction for the cursor/selector for content shown on the display 42 may be controlled by contact with “<<” indicia 45a and in the second direction by contact with “>>” indicia 47a. This is shown in FIG. 6. Similar to the other indicia 41a, 41b, 41c and 41d, there are corresponding touch sensors on the underside surface 100 of the front panel 44 for “<<” indicia 45a and “>>” indicia 47a.

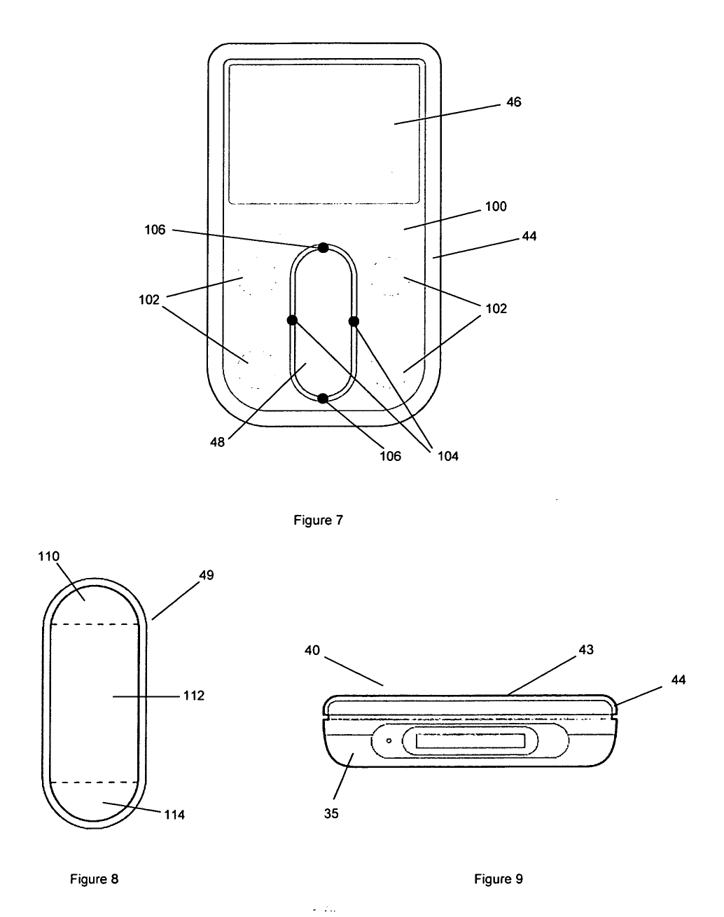

In addition, extra quick longtitudinal movement of a cursor/selector on the display 42 (compared to when using the scrolling activator 49) may be possible if a first curved side 37 of the rim 39 and a second curved side 36 of the rim 39 has corresponding touch sensors 106 located on the underside surface of the front panel 44 (FIG. 7). In this regard, there is thus feedback to confirm when extra quick movement of a cursor/selector on the display 42 is used by the user of the media player 40. The feedback may be an audible sound emanating from the tactile switch (like a mechanical “click”) or an audible sound generated from the media player 40 (like a digital “beep”). The feedback may also be in a form of a physical force like from a rebound of a pushbutton switch. Alternatively, the scrolling activator 49 may be divided into a plurality of zones 110, 112, 114 as shown in FIG. 8. The orientation of the scrolling activator 49 as shown is the same as when in use with the media player 40. The end zones 110, 114 of the scrolling activator 49 may be configured for extra quick longtitudinal movement of a cursor/selector on the display 42. The centre zone 112 may be configured to be used as an “enter” button when the centre zone 112 is tapped by the user. While only three zones are shown in FIG. 8, there may be more or less zones incorporated in the scrolling activator 49.

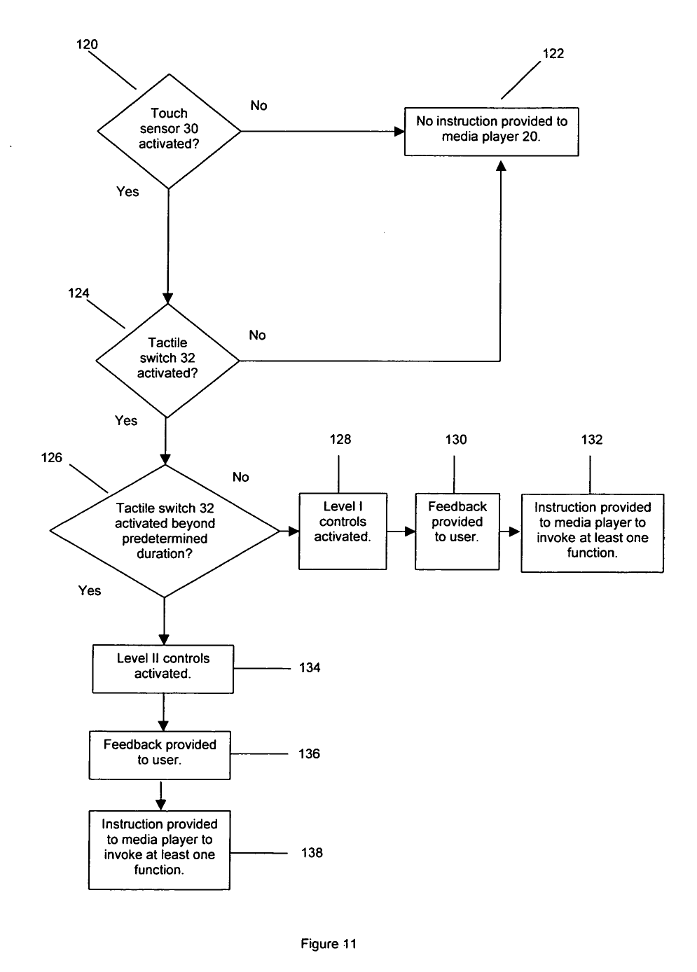

Referring to FIG. 11, there is shown an alternative method employed in the media player 20 to enable instructions to be provided to the media player 20. Firstly, a processor in the media player 20 may determine whether at least one touch sensor 30 is activated (120). If activation of at least one touch sensor 30 is not detected, then no instructions are sent to the media player 20 (122). If activation of at least one touch sensor 30 is detected, the processor in the media player 20 then determines whether the tactile switch 32 is activated (124). If activation of the tactile switch 32 is not detected, then no instructions are sent to the media player 20 (122). Subsequently, if activation of the tactile switch 32 is detected, the processor then determines whether the tactile switch 32 has been activated beyond a pre-determined duration (126). The pre-determined duration may be between two to three seconds only.

If the tactile switch 32 is not activated beyond the pre-determined duration, then controls on the front panel 24 remain at a first level, that is, the controls correspond to what are indicated by the indicia 28 on the front panel 24 (128). After the processor determines that the tactile switch 32 has not been activated beyond the pre-determined duration, feedback corresponding to the tactile switch 32 not being activated beyond the pre-determined duration is provided to a user (130). The feedback may be an audible sound emanating from the tactile switch (like a mechanical “click”) or an audible sound generated from the media player 20 (like a digital “beep”). The feedback may also be in a form of a physical force like from a rebound of a pushbutton switch. Subsequently, instructions are then provided to the media player 20 to invoke at least one function of the media player 20 (132).

If the tactile switch 32 is activated beyond the pre-determined duration, then controls on the front panel 24 switch to a second level, that is, the controls no longer correspond to what are indicated by the indicia 28 on the front panel 24 (134). Controls at the second level may be used to control or activate parameters of media content playback such as, for example, treble, bass, balance, surround effect and so forth. After the processor determines that the tactile switch 32 has been activated beyond the pre-determined duration, feedback corresponding to the tactile switch 32 being activated beyond the pre-determined duration is provided to a user (136). The feedback may be an audible sound emanating from the tactile switch 32 (like a mechanical “click”) or an audible sound generated from the media player 20 (like a digital “beep”). The feedback may also be in a form of a physical force like from a rebound of a pushbutton switch. It should be noted that the feedback generated for the tactile switch 32 that has been activated beyond the pre-determined duration differs from the feedback generated for the tactile switch 32 that has not been activated beyond the pre-determined duration. Subsequently, instructions are then provided to the media player 20 to invoke at least one function of the media player 20 (138). The controls on the front panel 24 may revert back to the first level either by activating the tactile switch 32 beyond the pre-determined duration or by automatic resetting after a period of time like one minute.

Whilst there has been described in the foregoing description preferred embodiments of the present invention, it will be understood by those skilled in the technology concerned that many variations or modifications in details of design or construction may be made without departing from the present invention.

1. A media player including:
a) a casing with a front panel mounted thereon;
b) the front panel including at least one touch sensor; and
c) at least one mechanical switch incorporated within the casing, wherein a combination of: activating at least one touch sensor, and activating the at least one mechanical switch at least once is required for the activation of at least one function from a first set of functions of the media player.

2. The media player of claim 1, further including a first opening for a display in the front panel.

3. The media player of claim 2, further including a scrolling activator located in the front panel for tasks selected from the group comprising: controlling longitudinal movement of a cursor/selector on the display and selecting items shown on the display.

4. The media player of claim 3, wherein the scrolling activator is located in a second opening in the front panel, the second opening is of a width that is greater than the scrolling activator.

5. The media player of claim 1, wherein the at least one touch sensor is coupled to the mechanical switch to provide an indication of an input when the at least one touch sensor on the front panel is activated.

6. The media player of claim 5, wherein the indication of an input is selected from the group comprising: a physical force, an audible sound emanating from the tactile switch and an audible sound generated from the media player.

7. The media player of claim 1, wherein the front panel is marked with indicia corresponding to positions of touch sensors.

8. The media player of claim 1, wherein the media player is selected from the group comprising: audio media player, a video media player, a digital photo viewer and a combination of the aforementioned.

9. The media player of claim 1, wherein the at least one mechanical switch is activated beyond a pre-determined duration to invoke a second set of functions of the media player.

10. The media player of claim 9, wherein the pre-determined duration is between two to three seconds.

11. A method to provide instructions to a media player, including:
determining whether a touch sensor is activated;
determining whether at least one mechanical switch is activated; and
determining the incidence of activation of the at least one mechanical switch, wherein feedback is provided to a user when a combination of the touch sensor and the at least one mechanical switch is activated, and instructions are provided to the media player.

12. The method of claim 11, wherein the feedback is selected from the group comprising: a physical force, an audible sound emanating from the tactile switch and an audible sound generated from the media player.

13. The method of claim 11, wherein the media player is selected from the group comprising: audio media player, a video media player, a digital photo viewer and a combination of the aforementioned.

14. A method to provide instructions to a media player, including:
determining whether a touch sensor is activated;
determining whether at least one mechanical switch is activated; and
determining whether the at least one mechanical switch is activated beyond a pre-determined duration, wherein feedback is provided to a user when a combination of the touch sensor and the at least one mechanical switch is activated, and instructions are provided to the media player.

15. The method of claim 14, wherein instructions are invoked from a second level of functions of the media player when the at least one mechanical switch is activated beyond a pre-determined duration.

16. The method of claim 14, wherein the pre-determined duration is between two to three seconds.

17. The method of claim 14, wherein the feedback is selected from the group comprising: a physical force, an audible sound emanating from the tactile switch and an audible sound generated from the media player.

18. The method of claim 14, wherein the media player is selected from the group comprising: audio media player, a video media player, a digital photo viewer and a combination of the aforementioned.
